(19) United States
(12) Patent Application Publication
(10) Pub. No.: US 2012/0003457 A1
(43) Pub. Date: Jan. 5, 2012

(54) FLAME-RETARDANT RESIN FORM AND FLAME-RETARDANT MATERIAL

(75) Inventors: Itsuhiro Hatanaka, Ibaraki-shi (JP); Kazumichi Kato, Ibaraki-shi (JP); Hiroki Fujii, Ibaraki-shi (JP); Makoto Saitou, Ibaraki-shi (JP); Tetsurou Kobayashi, Ibaraki-shi (JP)

(73) Assignee: NITTO DENKO CORPORATION, Ibaraki-shi, Osaka (JP)

(21) Appl. No.: 13/256,806

(22) PCT Filed: Mar. 3, 2010
(86) PCT No.: PCT/JP2010/053386

§ 371 Date: Sep. 15, 2011

(30) Foreign Application Priority Data
Mar. 19, 2009 (JP) 2009-067580
Feb. 24, 2010 (JP) 2010-038050

(51) Int. Cl. C09J 7/02; B32B 3/26; C08K 9/06; B32B 5/22

(52) U.S. Cl. 428/219; 428/317.9; 428/317.3; 521/134

(57) ABSTRACT

Provided is a frame-retardant resin foam which is highly expanded and is satisfactorily flexible so as to conform even to a minute clearance. The resin foam includes a resin and a flame-retardant component, in which the flame-retardant component is a polysiloxane-coated flame retarder. In the resin foam, the polysiloxane-coated flame retarder is preferably a polysiloxane-coated metal hydroxide, and the polysiloxane-coated metal hydroxide is contained preferably in a content of 30 to 60 percent by weight based on the total weight of the resin foam.

### TECHNICAL FIELD

The present invention relates to a frame-retardant foam which is flexible and has a high expansion ratio; and to a frame-retardant foam material using the frame-retardant foam.

### BACKGROUND ART

Foam materials (foam members) have been used in fixation of image display members to predetermined positions (e.g., fixing portions) of image display devices such as liquid crystal displays, electroluminescent displays, and plasma displays; and in fixation of cameras, lenses, and other optical members to predetermined positions (e.g., fixing portions) of so-called “cellular phones” and “mobile data terminals”. Such foam materials have recently been demanded to work as flame-retardant dustproof materials, from the viewpoint of product safety.

Such customary foam materials were usable without being compressed so much, because clearances in which the foam materials are to be used were sufficiently large in customary image display members mounted to liquid crystal displays, electroluminescent displays, plasma displays, and other image display devices and in cameras, lenses, and other optical members mounted to so-called “cellular phones” and “mobile data terminals”. Accordingly, there has been no need of worrying about compression repulsive force of the customary foam materials. Exemplary known foam materials include a gasket composed of a foam substrate and, adhered to one side of the substrate, a plastic film (see Patent Literature (PTL) 1); and a sealants for electric/electronic appliances, which is composed of a foam and, provided thereon, a pressure-sensitive adhesive layer (see PTL 2).

However, as a trend, clearances of portions where dustproof materials are to be used have decreased with decreasing thicknesses of products to which optical members (e.g., image display devices, cameras, and lenses) are to be mounted or set. For this reason, customary foam materials are becoming unusable due to their high repulsive force. Among them, frame-retardant foam materials significantly have high repulsive force as affected by their flame retardant components and thereby suffer from problems such as distortion of cabinets, and fracture and uneven displaying of display portions in use. To avoid these, there has been made a demand to provide a foam material which exhibits satisfactory dustproofness and good flame retardancy (inflammability) and which has such high flexibility as to conform even to a minute clearance (PTL 3).

### CITATION LIST

### Patent Literature

PTL 1: Japanese Unexamined Patent Application Publication (JP-A) No. 2001-100216
PTL 2: Japanese Unexamined Patent Application Publication (JP-A) No. 2002-309198
PTL 3: Japanese Unexamined Patent Application Publication (JP-A) No. 2005-97566

### SUMMARY OF INVENTION

### Technical Problem

In general, a frame-retardant foam using a metal oxide often has a very low expansion ratio and becomes excessively hard or rigid, because it often suffers from outgassing due to a low compatibility at the interface between a resin and the metal oxide. In addition, the metal oxide, if used in a large amount, may impair the fluidity of the resin and may impede the stretching of the resin in expansion, and this often causes the frame-retardant foam to have an insufficient expansion ratio.

Accordingly, an object of the present invention is to provide a frame-retardant resin foam which is highly expanded and is satisfactorily flexible so as to conform even to a minute clearance.

### Solution to Problem

After intensive investigations to achieve the object, the present inventors have found that the coating of a flame retarder on its surface with a silicone having high compatibility to the resin prevents outgassing from the interface between the resin and the flame retarder during expansion and thereby gives a frame-retardant resin foam having a high expansion ratio at previously unavailable level; and have found that the coating of a flame retarder on its surface with a silicone having high compatibility to the resin helps the resin to have improved fluidity and thereby helps the resin foam to have a higher expansion ratio more easily.

Specifically, the present invention provides, in an aspect, a resin foam including a resin and a flame-retardant component, in which the flame-retardant component is a polysiloxane-coated flame retarder.

In the resin foam according to the present invention, the polysiloxane-coated flame retarder may be a polysiloxane-coated metal hydroxide, and the polysiloxane-coated metal hydroxide may be contained in a content of from 30 to 60 percent by weight based on the total weight of the resin foam.

The resin foam preferably has a compression load at 50% compression of 3.0 N/cm² or less and has a flame retardancy of HBF rating or higher as determined in a frame-retardant test according to UL94 Flame Ratings.

The resin foam preferably has an expansion ratio of 9 times or more.

The resin foam preferably has a density of from 0.030 to 0.120 g/cm³.

In the resin foam, the resin may be a thermoplastic resin.

The resin foam may have a closed cell structure or semiopen/semiclosed cell structure.

The resin foam may have been formed through the steps of impregnating the resin with an inert gas under high pressure; and decompressing the impregnated resin.

In the resin foam, the inert gas at the impregnation may be carbon dioxide.

In the resin foam, the inert gas may be in a supercritical state at the impregnation.

The present invention also provides, in another aspect, a foam material including the resin foam.

The foam material may further include a pressure-sensitive adhesive layer present on or above one or both sides of the resin foam.

The foam material may further include a film layer present between the resin foam and the pressure-sensitive adhesive layer.

In the foam material, the pressure-sensitive adhesive layer may be an acrylic pressure-sensitive adhesive layer.

### Advantageous Effects of Invention

The foam according to the present invention has the above configuration, is highly expanded, has such satisfactory flexibility as to conform even to a minute clearance, and has flame retardancy.

### DESCRIPTION OF EMBODIMENTS

The resin foam according to the present invention is a resin foam containing a resin and a flame-retardant component, in which the flame-retardant component is a flame retarder coated with a polysiloxane (polysiloxane-coated flame retarder). The resin foam according to the present invention is generally formed by expanding and molding a resin composition containing a resin and a flame-retardant component.

### (Resin Composition)

The resin composition is a composition containing at least a resin and a flame-retardant component and forms a resin foam.

A material resin for the resin foam (hereinafter also briefly referred to as “foam”) herein is not limited, as long as being a polymer showing thermoplasticity (thermoplastic polymer) and being impregnatable with a high-pressure gas. Examples of such thermoplastic polymers include olefinic polymers such as low-density polyethylenes, medium-density polyethylenes, high-density polyethylenes, linear low-density polyethylenes, polypropylenes, copolymers between ethylene and propylene, copolymers between ethylene or propylene and another α-olefin, copolymers between ethylene and another ethylenically unsaturated monomer (e.g., vinyl acetate, acrylic acid, acrylic acid ester, methacrylic acid, methacrylic acid ester, or vinyl alcohol); styrenic polymers such as polystyrenes and acrylonitrile-butadiene-styrene copolymers (ABS resins); polyamides such as 6-nylon, 66-nylon, and 12-nylon; polyamideimides; polyurethanes; polyimides; polyetherimides; acrylic resins such as poly(methyl methacrylate) s; poly(vinyl chloride)s; poly(vinyl fluoride)s; alkenyl aromatic resins; polyesters such as poly(ethylene terephthalate)s and poly(butylene terephthalate)s; polycarbonates such as bisphenol-A polycarbonates; polyacetals; and poly(phenylene sulfide)s.

Examples of the thermoplastic polymers further include thermoplastic elastomers which show properties as rubber at normal temperature (room temperature) but show plasticity at high temperatures. Exemplary thermoplastic elastomers include olefinic elastomers such as ethylene-propylene copolymers, ethylene-propylene-diene copolymers, ethylene-vinyl acetate copolymers, polybutenes, polyisobutylenes, and chlorinated polyethylenes; styrenic elastomers such as styrene-butadiene-styrene copolymers, styrene-isoprene-styrene copolymers, styrene-isoprene-butadiene-styrene copolymers, and hydrogenated polymers of them; thermoplastic polyester elastomers; thermoplastic polyurethane elastomers; and thermoplastic acrylic elastomers. Each of these thermoplastic elastomers has a glass transition temperature typically of equal to or lower than room temperature (e.g., having a glass transition temperature of 20° C. or lower) and thereby gives a resin foam having significantly excellent flexibility and dimensional conformability.

Each of different thermoplastic polymers may be used alone or in combination. The material for the foam may be a thermoplastic elastomer; or another thermoplastic polymer than thermoplastic elastomer; or a mixture of a thermoplastic elastomer and another thermoplastic polymer than thermoplastic elastomer.

Examples of the mixture of a thermoplastic elastomer and another thermoplastic polymer than thermoplastic elastomer include a mixture of an olefinic elastomer (e.g., an ethylene-propylene copolymer) and an olefinic polymer (e.g., a polypropylene). The ratio of a thermoplastic elastomer to another thermoplastic polymer than thermoplastic elastomer, when used in combination as a mixture, is typically from about 1:99 to about 99:1, preferably from about 10:90 to about 90:10, and more preferably from about 20:80 to about 80:20.

The flame-retardant component for use herein is generally a polysiloxane-coated flame retarder. The polysiloxane-coated flame retarder exhibits flame retardancy and thermal stability both at higher levels, because it structurally includes a flame retarder coated with polysiloxane, in which the flame retarder helps the resin foam to have higher flame retardancy, and the polysiloxane is highly thermally stable. This flame-retardant component has higher compatibility with the resin due to coating with a polysiloxane, thereby has satisfactory dispersibility in the resin, does not impair the fluidity of the resin, and does not cause outgassing at the interface between the resin and the flame-retardant component when the resin composition containing the flame-retardant component is subjected to expansion and molding. In addition, the use of the polysiloxane-coated flame retarder as the flame-retardant component can reduce the amount of the flame-retardant component, and this contributes to improvements of expansion ratio.

The flame retarder is not limited and may be any of known or customary flame retarders for use typically with polyolefinic resins. Among them, metal hydroxides are preferably used.

Exemplary metal elements for constituting the metal hydroxide include aluminum (Al), magnesium (Mg), calcium (Ca), nickel (Ni), cobalt (Co), tin (Sn), zinc (Zn), copper (Cu), iron (Fe), titanium (Ti), and boron (B). Among them, preferred examples are aluminum and magnesium. The metal hydroxide may be composed of one metal element or may be composed of two or more different metal elements. Preferred examples of metal hydroxides each composed of one metal element for use herein include aluminum hydroxide and magnesium hydroxide.

The metal hydroxide is also preferably a composite metal hydroxide which is a metal hydroxide composed of two or more different metal elements. Representative examples of such composite metal hydroxides include sMgO.(1-s)NiO.cH₂O [wherein 0<s<1 and 0<c≦1], sMgO.(1-s)ZnO.cH₂O [wherein 0<s<1 and 0<c≦1], and sAl₂O₃.(1-s)Fe₂O₃.cH₂O [wherein 0<s<1 and 0<c≦3]. Of these, composite metal hydroxides composed of magnesium with nickel and/or zinc are most preferred. Specifically, particularly preferred are composite metal hydroxides represented by sMgO.(1-s)Q¹O.cH₂O [wherein Q¹ represents Ni or Zn; 0<s<1; and 0<c≦1], such as a hydroxide of magnesium oxide-nickel oxide, and a hydroxide of magnesium oxide-zinc oxide. Such a composite metal hydroxide may have a polyhedral shape or thin planar shape. The use of a polyhedral composite metal hydroxide may give a resin foam having a higher expansion ratio.

Though not critical, the average particle diameter (average particle size) of the flame retarder (of which the metal hydroxide is preferred) is preferably from about 0.1 to about 10 μm, and more preferably from about 0.2 to about 7 μm. The average particle size may be measured typically with a laser particle size analyzer. With a decreasing particle diameter, the specific surface area increases and the flame retardancy increases. The flame retarder, if having a particle diameter of more than 10 μm, may often cause the resin foam to have an insufficient expansion ratio and to fail to be a highly expanded resin foam. The flame retarder, if having a particle diameter of less than 0.1 μm, may be readily blown around as dust and may thereby have poor handleability.

The flame retarder for use in the present invention is coated with a polysiloxane. The flame retarder before coating with a polysiloxane may undergo a surface treatment. Specifically, the polysiloxane-coated flame retarder herein may be prepared by applying a surface treatment to a flame retarder as a core component; and coating the surface-treated flame retarder with a polysiloxane. A surface-treated flame retarder, when used as the flame retarder before coating with a polysiloxane, may have higher adhesion to the polysiloxane coating and may have higher coating performance, thus being advantageous.

A way to perform the surface treatment may be, but not limited to, a surface treatment technique with a surface treating agent (coupling agent). Exemplary surface treating agents include, but are not limited to, aluminum compounds (aluminum coupling agents), silane compounds (silane coupling agents), titanate compounds (titanate coupling agents), amino compounds (amino coupling agents), epoxy compounds, isocyanate compounds, higher fatty acids or salts of them, higher unsaturated fatty acids, phosphoric esters, silicone oligomers, reactive silicone oils, and thermoplastic resins. Among them, silane compounds are preferred for their satisfactory adhesion to the polysiloxane coating. Each of different surface treating agents may be used alone or in combination.

Though not critical, the amount of surface treating agents is, typically when a metal hydroxide is used as the flame retarder, preferably from 0.1 to 10 parts by weight, and more preferably from 0.3 to 8 parts by weight, per 100 parts by weight of the metal hydroxide. Surface preparation agents, if used in an amount of less than 0.1 part by weight, may not exhibit sufficient effects upon their use. In contrast, surface treating agents, if used in an amount of more than 10 parts by weight, may cause an excessively large particle size of the flame retardant component and may thereby cause outgassing during expansion.

Exemplary ways to apply a surface treatment with a surface treating agent to the flame retarder include, but are not limited to, known or customary processes such as dry process, wet process, and integral blending process, when a metal hydroxide is used as the flame retarder.

The polysiloxane for use in coating of the flame retarder is not limited, as long as being a polymer having siloxane bonds as a main backbone, but is preferably a polyorganosiloxane having an average composition formula represented by Formula (1) below. The polysiloxane preferably has a linear molecular structure but may partially include a branched-chain structure.

[Chem. 1]

RₐSiO_{(4-a)/2} (1)

In Formula (1), Rs each represent a substituted or unsubstituted monovalent hydrocarbon group; and “a” denotes a positive number.

The groups R in the polyorganosiloxane represented by Average Composition Formula (1) may each generally have 1 to 10 carbon atoms, and preferably 1 to 8 carbon atoms.

In the polyorganosiloxane represented by Average Composition Formula (1), examples of the hydrocarbon groups Rs include alkyl groups such as methyl group, ethyl group, propyl group, and butyl group; alkenyl groups such as vinyl group, allyl group, and butenyl group; aryl groups such as phenyl group and tolyl groups; substituted hydrocarbon groups corresponding to the alkyl groups, alkenyl group, and aryl groups, except with part or all of hydrogen atoms bonded to carbon atom(s) being substituted by a halogen atom and/or cyano group. The hydrocarbon groups Rs may be the same as or different from each other.

Exemplary substituted hydrocarbon groups as the hydrocarbon groups Rs include chloromethyl group, chloropropyl group, 3,3,3-trifluoropropyl group, and 2-cyanoethyl group.

The number “a” in Average Composition Formula (1) may be a positive number of from 1.95 to 2.05, because the polyorganosiloxane represented by Average Composition Formula (1) preferably has a linear molecular structure but may partially include a branched-chain structure.

Though not critical, the amount of the polysiloxane in the polysiloxane-coated flame retarder is preferably from 0.1 to 15 percent by weight, and more preferably from 1.0 to 10 percent by weight, based on the total weight of the flame retarder and the polysiloxane, from the viewpoints of flame retardancy and handleability. The polysiloxane, if present in an amount of less than 0.1 percent by weight, may not provide sufficient flame retardancy and may not provide satisfactory fluidity. The polysiloxane, if present in an amount of more than 15 percent by weight, may cause an excessively large average particle diameter of the flame-retardant component to cause the resin foam to have an insufficient expansion ratio.

The polysiloxane-coated flame retarder may be prepared by mixing/dispersing or kneading the polysiloxane and the flame retarder with each other. Such mixing/dispersing or kneading may be performed under a pressure (under a load) of from about 0.1 to about 10 MPa.

In the present invention, the flame retarder is preferably a metal oxide; and the polysiloxane for coating the flame retarder is preferably a polyorganosiloxane represented by Average Composition Formula (1). Accordingly, a metal oxide coated with a polyorganosiloxane represented by Average Composition Formula (1) is preferably used as the polysiloxane-coated flame retarder working as the flame-retardant component.

The smaller the content of the flame-retardant component in the resin composition is, the better for providing a highly expanded foam. For example, the content of a polysiloxane-coated flame retarder (e.g., polysiloxane-coated metal oxide) as the flame-retardant component in the resin composition is, but not limited to, preferably from 30 to 60 percent by weight, and more preferably from 35 to 55 percent by weight, based on the total weight of the resin foam, from the viewpoints of expansion ratio and flame retardancy. The polysiloxane-coated flame retarder, if present in an amount of less than 30 parts by weight, may not provide sufficient flame retardancy. In contrast, the polysiloxane-coated flame retarder, if present in an amount of more than 60 parts by weight, may cause the resin composition to have an increasing expansional viscosity to thereby decrease the expansion ratio, and to fail to give a highly expanded foam.

The resin foam according to the present invention may further contain one or more additives according to necessity. The additives are not limited on their types and may be various additives generally used in expansion molding. Exemplary additives include foaming nucleators, crystal nucleators, plasticizers, lubricants, colorants (e.g., pigments and dyestuffs), ultraviolet absorbers, antioxidants, age inhibitors, fillers, reinforcers, antistatic agents, surfactants, vulcanizers, and surface treating agents. The amounts of additives may be suitably chosen within ranges not adversely affecting, for example, the formation of bubbles (cells) and may be such amounts that are generally employed in expansion/molding of resins. Each of different additives may be used alone or in combination.

The lubricants help the resin to have higher fluidity and to less suffer from thermal degradation. Such lubricants for use herein are not limited, as long as being capable of helping the resin to have higher fluidity, and examples thereof include hydrocarbon lubricants such as liquid paraffins, paraffin waxes, microcrystalline waxes, and polyethylene waxes; fatty acid lubricants such as stearic acid, behenic acid, and 12-hydroxystearic acid; and ester lubricants such as butyl stearate, stearic acid monoglyceride, pentaerythritol tetrastearate, hydrogenated caster oil, and stearyl stearate. Each of different lubricants may be used alone or in combination.

Lubricants may be used in an amount of typically from 0.5 to 10 parts by weight, preferably from 0.8 to 8 parts by weight, and more preferably from 1 to 6 parts by weight, per 100 parts by weight of the resin. Lubricants, if used in an amount of more than 10 parts by weight, may cause the resin composition to have excessively high fluidity and may thereby cause the resin foam to have an insufficient expansion ratio. Lubricants, if used in an amount of less than 0.5 part by weight, may not sufficiently effectively help the resin to have satisfactory fluidity and may cause the resin to stretch insufficiently upon expansion, and this may cause the resin foam to have an insufficient expansion ratio.

The shrinkage inhibitors help to form molecular films (monolayers) on surfaces of cell membranes (cell walls) of the foam to effectively block the permeation of the blowing agent gas. Such shrinkage inhibitors for use herein are not limited, as long as having the function of blocking the permeation of the blowing agent gas. The shrinkage inhibitors may be any of metal salts of fatty acids and fatty amides. Exemplary metal salts of fatty acids include aluminum, calcium, magnesium, lithium, barium, zinc, and lead salts of fatty acids such as stearic acid, behenic acid, and 12-hydroxystearic acid. Exemplary fatty amides include fatty amides whose fatty acid moiety having about 12 to about 38 carbon atoms (preferably having about 12 to about 22 carbon atoms), such as stearamide, oleamide, erucamide, methylene bis(stearamide), ethylene bis(stearamide), and lauric bisamide. Such fatty amides may be either monoamides or bisamides, of which bisamides are preferred for giving a fine cell structure. Each of different shrinkage inhibitors may be used alone or in combination.

Shrinkage inhibitors may be used in an amount of typically from 0.5 to 10 parts by weight, preferably from 0.7 to 8 parts by weight, and more preferably from 1 to 6 parts by weight, per 100 parts by weight of the resin. Shrinkage inhibitors, if used in an amount of more than 10 parts by weight, may lower the gas efficiency during the cell growth process, and the resulting foam may include unexpanded portions in large amounts and may expand at an insufficient expansion ratio, although it includes cells with small diameters. Shrinkage inhibitors, if used in an amount of less than 0.5 part by weight, may not sufficiently help to form films over cell walls, and this may cause outgassing during expansion and cause shrinkage of the foam, resulting in an insufficient expansion ratio of the foam.

Different types of additives, e.g., a lubricant and a shrinkage inhibitor, may be used in combination. Typically, one or more lubricants (e.g., stearic acid monoglyceride) may be used in combination with one or more shrinkage inhibitors (e.g., erucamide and lauric bisamide).

The resin composition may be prepared according to a known or customary technique. Typically, the resin composition may be prepared by kneading a resin with a flame-retardant component (polysiloxane-coated flame retarder), and additives according to necessity. The kneading may be performed with heating.

The resin composition contains a polysiloxane-coated flame retarder and thereby shows satisfactory handleability, without deterioration of resin fluidity caused by the flame-retardant component.

The resin composition may have an expansional viscosity of from 30 to 90 kPa·s, and preferably from 40 to 70 kPa·s as measured with a capillary rheometer at a temperature of 180° C. and a shear rate of 100 [1/s]. The resin composition, as having an expansional viscosity at this level, is resistant to fracture of cell walls during its expansion molding and thereby gives a foam with a high expansion ratio. In addition, the resulting foam may have a large thickness because a die pressure at certain level may be maintained even with a large gap. The resin composition, if having an expansional viscosity of less than 30 kPa·s, may fail to give a desired expansion ratio or cause outgassing during expansion molding. In contrast, the resin composition, if having an expansional viscosity of more than 90 kPa·s, may have insufficient formability and may fail to give a foam having a smooth surface.

### (Production of Resin Foam)

Ways to form the resin foam are not limited and include customary techniques such as physical techniques and chemical techniques. An exemplary customary physical technique is a technique in which a low-boiling liquid (blowing agent), such as a chlorofluorocarbon or a hydrocarbon, is dispersed in a resin, and the resin bearing the blowing agent is heated to volatilize the blowing agent to thereby form bubbles (cells). An exemplary customary chemical technique is a technique of adding a compound (blowing agent) to a resin, and thermally decomposing the blowing agent to form a gas to thereby form bubbles (cells). However, if expansion or foaming is performed according to the customary physical technique as above, there may occur problems about the combustibility, toxicity, and influence on the environment (such as ozone layer depletion) caused by the material used as the blowing agent. Independently, if foaming is performed according to the customary chemical technique, the residue of the blowing agent gas remains in the foam; this causes problems such as, in the case of the blowing agent being corrosive, corrosion by the corrosive gas, and contamination by impurities in the gas, and these troubles are significant especially in electronic appliances where contamination should be essentially avoided. In addition, the customary physical and chemical foaming techniques are believed to be difficult to give a fine cell structure and to be very difficult to give fine bubbles (micro cells) of 300 μm or less.

To avoid the above problems and to give a foam having a small cell diameter and a high cell density easily, the foaming herein is preferably performed according to a technique using a high-pressure inert gas as the blowing agent.

Specific examples of ways to produce the resin foam from a resin composition by using a high-pressure inert gas as the blowing agent include a process including the steps of impregnating the resin with an inert gas under high pressure (gas impregnation step); decompressing the impregnated resin after the gas impregnation step to expand the resin (decompression step); and, where necessary, heating the expanded resin for cell growth (heating step). In this process, it is accepted that the resin composition is previously molded to give an unexpanded molded article, and the unexpanded molded article is impregnated with an inert gas; or that the resin composition is melted, and the molten resin is impregnated with an inert gas under pressure (under a load), and the impregnated resin is molded upon decompression. Each of these steps may be performed according to a batch system or continuous system.

The inert gas for use herein is not especially limited, as long as being inert to the resin and being impregnatable into the resin. Exemplary inert gases include carbon dioxide, nitrogen gas, and air. These gases may be used in combination as a mixture. Of these, carbon dioxide is preferred, because it can be impregnated in a large amount at a high rate into the resin to be used as a material for constituting the foam. Carbon dioxide is also preferred from the viewpoint of giving a resin foam which contains less impurities and is clean.

The inert gas at the impregnation into the resin is preferably in a supercritical state. The inert gas, when being in a supercritical state, shows increased solubility in the resin and can thereby be incorporated into the resin in a higher concentration. In addition, because of its high concentration, the supercritical inert gas generates a larger number of cell nuclei upon an abrupt pressure drop (decompression) after impregnation. These cell nuclei grow to give cells which are present in a higher density than in a foam having the same porosity and prepared with the same gas but in another state. Consequently, the use of a supercritical inert gas can give fine micro cells. Carbon dioxide has a critical temperature and a critical pressure of 31° C. and 7.4 MPa, respectively.

The inert gas may be impregnated into the resin in an amount of, but not limited to, preferably from 1.0 to 10.0 percent by weight, and more preferably from 1.5 to 7.5 percent by weight, relative to the total amount of the resin, for controlled pressure during expansion. The inert gas, if impregnated into the resin in an excessively small amount, may narrow the range of pressure control during expansion; and in contrast, the inert gas, if impregnated into the resin in an excessively large amount, may impede the pressure control.

According to the batch system, a resin foam may be prepared typically in the following manner. Initially, an unexpanded molded article (e.g., a resin sheet for the formation of foam) is formed by extruding the resin composition through an extruder such as a single-screw extruder or twin-screw extruder. Alternatively, such an unexpanded molded article (e.g., a resin sheet for the formation of foam) is formed by uniformly kneading the resin composition in a kneading machine equipped with one or more blades typically of roller, cam, kneader, or Banbury type; and press-forming the kneadate using a hot-plate press. The resulting unexpanded molded article is placed in a pressure-tight vessel, into which a high-pressure inert gas is injected, and the unexpanded molded article is thereby impregnated with the inert gas. In this case, the unexpanded molded article is not especially limited in shape and can be in any form such as a roll form or sheet form. The injection of the high-pressure inert gas may be performed continuously or discontinuously. At the time when the unexpanded molded article is sufficiently impregnated with the high-pressure inert gas, the unexpanded molded article is released from the pressure (the pressure is usually lowered to atmospheric pressure) to thereby generate cell nuclei in the resin. The cell nuclei may be allowed to grow at room temperature without heating, or may be allowed to grow by heating according to necessity. The heating may be performed according to a known or common procedure such as heating with a water bath, oil bath, hot roll, hot-air oven, far-infrared rays, near-infrared rays, or microwaves. After the cells have grown in the above manner, the article (foam) is rapidly cooled typically with cold water to fix its shape.

According to the continuous system, a resin foam may be formed typically in the following manner. Specifically, the resin composition is kneaded in an extruder such as a single-screw extruder or twin-screw extruder, and during the kneading, a high-pressure inert gas is injected so as to impregnate the resin with the gas sufficiently. The resulting article is then extruded and thereby released from the pressure (the pressure is usually lowered to atmospheric pressure) to perform expansion and molding simultaneously to thereby allow cells to grow. In some cases, heating is performed to assist the cell growth. After the cell growth, the extrudate is rapidly cooled typically with cold water to fix its shape.

The pressure in the gas impregnation step is typically 6 MPa or more (e.g., from about 6 to about 100 MPa), and preferably 8 MPa or more (e.g., from about 8 to about 100 MPa). If the pressure of the inert gas is less than 6 MPa, considerable cell growth may occur during foaming, and this may cause the cells to have too large diameters to give a small average cell diameter within the above-specified range and may cause insufficient dustproofing effects. The reasons for this are as follows. When impregnation is performed under a low pressure, the amount of the impregnated gas is relatively small and the cell nuclei grow at a lower rate as compared to impregnation under a high pressure. As a result, cell nuclei are formed in a smaller number. Because of this, the gas amount per each cell increases rather than decreases, resulting in excessively large cell diameters. Furthermore, under pressures lower than 6 MPa, merely a slight change in impregnation pressure results in considerable changes in cell diameter and cell density, and this may often impede the control of cell diameter and cell density.

The temperature in the gas impregnation step may vary depending typically on the types of the inert gas and resin to be used and may be chosen within a wide range. When impregnation operability and other conditions are taken into account, the impregnation temperature is typically from about 10° C. to about 350° C. For example, when an unfoamed molded article in a sheet form is impregnated with an inert gas according to a batch system, the impregnation temperature is typically from about 10° C. to about 250° C., preferably from about 40° C. to about 230° C. When a molten resin composition is impregnated with a gas and is extruded to perform expansion and molding simultaneously according to a continuous system, the impregnation temperature is generally from about 60° C. to about 350° C. When carbon dioxide is used as the inert gas, the impregnation temperature is preferably 32° C. or higher and more preferably 40° C. or higher in order to keep carbon dioxide in a supercritical state.

The decompression in the decompression step is preferably performed at a decompression rate of from about 5 to about 300 MPa/second, for obtaining more uniform fine cells. The heating in the heating step may be performed at a temperature of typically from about 40° C. to about 250° C., and preferably from about 60° C. to about 250° C.

### (Resin Foam)

The resin foam according to the present invention may be generally formed from a resin composition containing a resin and a flame-retardant component through expansion/molding. The resin foam has flame retardancy of a high order, as containing a polysiloxane-coated flame retarder as the flame-retardant component. Specifically, the resin foam preferably has a flame retardancy of HBF rating or higher as determined in a frame-retardant test according to UL (Underwriter's Laboratories, Inc. standard) 94 Flame Classifications.

The resin foam has a repulsive load at 50% compression of preferably 3.0 N/cm² or less, and more preferably 2.0 N/cm² or less, for suppressing distortion caused by the repulsive force when the resin foam is adopted to appliances. The repulsive load at 50% compression of the resin foam may be measured in accordance with the method of measuring a compression hardness prescribed in Japanese Industrial Standards (JIS) K 6767.

The resin foam according to the present invention has an expansion ratio of preferably 9 times or more (e.g., from 9 times to 50 times), and more preferably 12 times or more (e.g., from 12 times to 30 times) for satisfactory shock absorptivity, light weight, and satisfactory flexibility. The resin foam, if having an expansion ratio of less than 9 times, may not exhibit sufficient shock absorptivity or may not have such sufficient flexibility as to conform to a minute clearance. In contrast, the resin foam, if having an expansion ratio of more than 50 times, may have significantly insufficient strength.

An exemplary clearance as the minute clearance herein is a clearance of from 0.10 to 0.30 mm.

The expansion ratio of the resin foam may be calculated according to the following expression:

Expansion ratio (time)=(Density before expansion)/(Density after expansion)

The density before expansion corresponds to the density of an unexpanded molded article, or to the density of a resin composition before expansion in the case when the resin composition is molten, and the molten resin is impregnated with an inert gas to form the resin foam. The density after expansion corresponds to the density of the resin foam.

The resin foam according to the present invention has a density of preferably from 0.030 to 0.120 g/cm³, and more preferably from 0.045 to 0.100 g/cm³ for satisfactory shock absorptivity and flexibility. The resin foam, if having a density of less than 0.030 g/cm³, may show remarkably insufficient strength. In contrast, the resin foam, if having a density of more than 0.120 g/cm³, may fail to show enough sufficient shock absorptivity or to conform to a minute clearance.

The resin foam preferably has a cell structure of closed cell structure or semiopen/semiclosed cell structure, for satisfactory sealability, dustproofness, and waterproofness. The semiopen/semiclosed cell structure is a cell structure in which a closed cell structure and an open cell structure are present in coexistence, whereas the ratio between the two structures is not limited. In particular, the resin foam preferably has such a cell structure that a closed cell structure region occupies 80% or more, and more preferably 90% or more of the resin foam.

The flame retardancy of the resin foam may be controlled typically by selecting the resin, selecting the type of the flame retarder to be coated, selecting the structure of the polysiloxane, and/or regulating the amount of the flame-retardant component.

The repulsive load at 50% compression, density, expansion ratio, and cell structure of the resin foam may be controlled by suitably choosing or setting expansion molding conditions according to the type of the resin, the type of the blowing agent, and the types of flame-retardant component and other additives. Such expansion molding conditions include operation conditions in the gas impregnation step, such as temperature, pressure, and time; operation conditions in the decompression step, such as decompression rate, temperature, and pressure; and temperature of heating after decompression.

As has been described above, the resin foam according to the present invention has both satisfactory flexibility and good flame retardancy, is highly expanded and lightweight, and is capable of conforming to a minute clearance. The resin foam is therefore advantageously usable as sealants, cushioning sealants, shock absorbers, dustproof materials, soundproof materials, and waterproof materials.

The resin foam has the above-mentioned properties, is capable of filling in a minute clearance between densely packaged components, and is thereby usable typically in members or components, electronic components, and electronic appliances, particularly advantageously when they are compact and/or slim. Typically, the resin foam is advantageously usable in liquid crystal display devices such as liquid crystal displays, electroluminescent displays, and plasma displays; and apparatuses for mobile communications, such as cellular phones and mobile data terminals (personal digital assistants).

### (Frame-Retardant Foam Material)

The frame-retardant foam material includes at least the resin foam. Specifically, the frame-retardant foam material may structurally include the resin foam alone or may include one or more other layers and/or substrates (of which pressure-sensitive adhesive layers are preferred) on or above one or both sides of the resin foam.

The frame-retardant foam material, when further including a pressure-sensitive adhesive layer on or above one or both sides of the resin foam, enables the fixation or temporal fixation of a member or component (such as optical member) to an adherend.

A pressure-sensitive adhesive for constituting the pressure-sensitive adhesive layer is not limited and may be suitably chosen from among known pressure-sensitive adhesives such as acrylic pressure-sensitive adhesives, rubber pressure-sensitive adhesives (e.g., natural rubber pressure-sensitive adhesives and synthetic rubber pressure-sensitive adhesives), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, and fluorine-containing pressure-sensitive adhesives. Each of different pressure-sensitive adhesives may be used alone or in combination. The pressure-sensitive adhesives may be pressure-sensitive adhesives of any type, such as emulsion pressure-sensitive adhesives, hot-melt pressure-sensitive adhesives, solvent-borne pressure-sensitive adhesives, oligomer pressure-sensitive adhesives, and solid pressure-sensitive adhesives. Of such pressure-sensitive adhesives, acrylic pressure-sensitive adhesives are preferred from the viewpoint typically of preventing contamination to the adherend.

The pressure-sensitive adhesive layer may be formed according to a known or customary process. Exemplary formation processes include a coating process in which a pressure-sensitive adhesive is applied to a predetermined site or surface to form a pressure-sensitive adhesive layer thereon; and a transfer process in which a pressure-sensitive adhesive is applied to a release liner or another release film to form a pressure-sensitive adhesive layer thereon, and the formed pressure-sensitive adhesive layer is transferred to a predetermined site or surface. The formation of the pressure-sensitive adhesive layer may be performed by suitably using a known or common coating procedure such as flow casting, coating with a roll coater, coating with a reverse coater, or coating with a doctor blade.

The pressure-sensitive adhesive layer has a thickness of generally from about 2 to about 100 μm, and preferably from about 10 to about 100 μm. The thickness of the pressure-sensitive adhesive layer is preferably minimized, because such a thin pressure-sensitive adhesive layer can be more effectively prevented from the attachment of dirt or dust at the edges thereof. The pressure-sensitive adhesive layer may have a single-layer structure or multilayer structure.

The pressure-sensitive adhesive layer may be present above the foam with the interposition of one or more other layers (underlayers). Exemplary underlayers include carrier layers (of which film layers are preferred); other pressure-sensitive adhesive layers; intermediate layers; and under coats.

When the pressure-sensitive adhesive layer is present on or above only one side of the foam, one or more other layers may be present on the other side of the foam. Exemplary other layers herein include pressure-sensitive adhesive layers of other types; and carrier layers.

The frame-retardant foam material and the resin foam constituting the frame-retardant foam material may each have been subjected to processing so as to have desired dimensions such as shape and thickness. Typically, the frame-retardant foam material may be sliced to give a frame-retardant foam material having a desired thickness. Independently, the frame-retardant foam material and the resin foam may have been processed into a variety of shape according typically to an apparatus or instrument to which the frame-retardant foam material will be adopted.

The frame-retardant foam material is advantageously usable typically as sealants, cushioning sealants, shock absorbers, dustproof materials, soundproof materials, and waterproof materials.

The frame-retardant foam material is advantageously usable particularly typically in an electronic appliance. This is because the resin foam constituting the frame-retardant foam material is highly flexible, employs carbon dioxide or another inert gas as a blowing agent for the production thereof, is thereby free from the generation of harmful substances or the remaining of contaminating substances, and is clean.

The frame-retardant foam material may be used typically in mounting or installing of a member or component (e.g., an optical member) to a predetermined position. In particular, the flame-retardant foam material is advantageously usable even in mounting of a compact member or component (e.g., a compact optical member) to a slimmed product.

Exemplary optical members to be mounted or installed through the flame-retardant foam material include image display members (of which small-sized image display members are preferred) to be mounted to image display devices such as liquid crystal display devices, electroluminescent display devices, and plasma display devices; and cameras and lenses (of which small-sized cameras and lenses are preferred) to be mounted to mobile communication devices such as so-called “cellular phones” and “mobile data terminals”.

In addition, exemplary members to be mounted through the frame-retardant foam material includes batteries and hard disk drives (HDDs).

### EXAMPLES

The present invention will be illustrated in further detail with reference to several working examples below. It should be noted, however, that these examples are never construed to limit the scope of the present invention.

### Example 1

In a twin-screw kneader (supplied by The Japan Steel Works, LTD. (JSW)) were kneaded, at a temperature of 200° C., 45 parts by weight of a polypropylene [melt flow rate (MFR): 0.35 g/10 min], 55 parts by weight of a polyolefinic elastomer [melt flow rate (MFR): 6 g/10 min, JIS-A hardness: 79°], 60 parts by weight of a polysiloxane-coated magnesium hydroxide (trade name “FRX-100” supplied by Shin-Etsu Chemical Co., Ltd., average particle size: 1.0 μm, mass of coating: 6.0 percent by weight), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Example 2

In a twin-screw kneader (supplied by The Japan Steel Works, LTD. (JSW)) were kneaded, at a temperature of 200° C., 45 parts by weight of a polypropylene [melt flow rate (MFR): 0.35 g/10 min], 55 parts by weight of a polyolefinic elastomer [melt flow rate (MFR): 6 g/10 min, JIS-A hardness: 79°], 90 parts by weight of a polysiloxane-coated magnesium hydroxide (trade name “FRX-100” supplied by Shin-Etsu Chemical Co., Ltd., average particle size: 1.0 μm, mass of coating: 6.0 percent by weight), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Example 3

In a twin-screw kneader (supplied by The Japan Steel Works, LTD. (JSW)) were kneaded, at a temperature of 200° C., 45 parts by weight of a polypropylene [melt flow rate (MFR): 0.35 g/10 min], 55 parts by weight of a polyolefinic elastomer [melt flow rate (MFR): 6 g/10 min, JIS-A hardness: 79°], 120 parts by weight of a polysiloxane-coated magnesium hydroxide (trade name “FRX-100” supplied by Shin-Etsu Chemical Co., Ltd., average particle size: 1.0 μm, mass of coating: 6.0 percent by weight), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Example 4

In a twin-screw kneader (supplied by The Japan Steel Works, LTD. (JSW)) were kneaded, at a temperature of 200° C., 50 parts by weight of a polypropylene [melt flow rate (MFR): 0.35 g/10 min], 50 parts by weight of a polyolefinic elastomer [melt flow rate (MFR): 6 g/10 min, JIS-A hardness: 79°], 120 parts by weight of a polysiloxane-coated magnesium hydroxide (trade name “FRX-100” supplied by Shin-Etsu Chemical Co., Ltd., average particle size: 1.0 μm, mass of coating: 6.0 percent by weight), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Example 5

In a twin-screw kneader (supplied by The Japan Steel Works, LTD. (JSW)) were kneaded, at a temperature of 200° C., 50 parts by weight of a polypropylene [melt flow rate (MFR): 0.35 g/10 min], 50 parts by weight of a polyolefinic elastomer [melt flow rate (MFR): 6 g/10 min, JIS-A hardness: 79°], 75 parts by weight of a polysiloxane-coated magnesium hydroxide (trade name “FRX-100” supplied by Shin-Etsu Chemical Co., Ltd., average particle size: 1.0 μm, mass of coating: 6.0 percent by weight), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Example 6

In a twin-screw kneader (supplied by The Japan Steel Works, LTD. (JSW)) were kneaded, at a temperature of 200° C., 65 parts by weight of a polypropylene [melt flow rate (MFR): 0.35 g/10 min], 35 parts by weight of a polyolefinic elastomer [melt flow rate (MFR): 6 g/10 min, JIS-A hardness: 79°], 75 parts by weight of a polysiloxane-coated magnesium hydroxide (trade name “FRX-100” supplied by Shin-Etsu Chemical Co., Ltd., average particle size: 1.0 μm, mass of coating: 6.0 percent by weight), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Comparative Example 1

In a twin-screw kneader (supplied by The Japan Steel Works, LTD. (JSW)) were kneaded, at a temperature of 200° C., 45 parts by weight of a polypropylene [melt flow rate (MFR): 0.35 g/10 min], 55 parts by weight of a polyolefinic elastomer [melt flow rate (MFR): 6 g/10 min, JIS-A hardness: 79°], 10 parts by weight of a silane-coupling-agent-treated magnesium hydroxide (trade name “KISUMA 5A” supplied by Kyowa Chemical Industry Co., Ltd., average particle size: 0.8 μm), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Comparative Example 2

In a twin-screw kneader (supplied by The Japan Steel Works, LTD. (JSW)) were kneaded, at a temperature of 200° C., 45 parts by weight of a polypropylene [melt flow rate (MFR): 0.35 g/10 min], 55 parts by weight of a polyolefinic elastomer [melt flow rate (MFR): 6 g/10 min, JIS-A hardness: 79°], 60 parts by weight of a silane-coupling-agent-treated magnesium hydroxide (trade name “KISUMA 5A” supplied by Kyowa Chemical Industry Co., Ltd., average particle size: 0.8 μm), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Comparative Example 3

In a twin-screw kneader (supplied by The Japan Steel Works, LTD. (JSW)) were kneaded, at a temperature of 200° C., 45 parts by weight of a polypropylene [melt flow rate (MFR): 0.35 g/10 min], 55 parts by weight of a polyolefinic elastomer [melt flow rate (MFR): 6 g/10 min, JIS-A hardness: 79°], 90 parts by weight of a silane-coupling-agent-treated magnesium hydroxide (trade name “KISUMA 5A” supplied by Kyowa Chemical Industry Co., Ltd., average particle size: 0.8 μm), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

### Comparative Example 4

In a twin-screw kneader (supplied by The Japan Steel Works, LTD. (JSW)) were kneaded, at a temperature of 200° C., 45 parts by weight of a polypropylene [melt flow rate (MFR): 0.35 g/10 min], 55 parts by weight of a polyolefinic elastomer [melt flow rate (MFR): 6 g/10 min, JIS-A hardness: 79°], 120 parts by weight of a silane-coupling-agent-treated magnesium hydroxide (trade name “KISUMA 5A” supplied by Kyowa Chemical Industry Co., Ltd., average particle size: 0.8 μm), 10 parts by weight of a carbon product (trade name “Asahi #35” supplied by Asahi Carbon Co., Ltd.), 1 part by weight of stearic acid monoglyceride, and 1 part by weight of a fatty bisamide (lauric bisamide). The kneadate was extruded into strands, cooled with water, and formed into pellets. The pellets (resin composition) were charged into a single-screw extruder (supplied by JSW), and carbon dioxide gas was injected at an atmospheric temperature of 220° C. and a pressure of 13 MPa, where the pressure became 12 MPa after injection. The carbon dioxide gas was injected in an amount of 6.0 percent by weight relative to the total weight of the polymer. After being sufficiently saturated with the carbon dioxide gas, the resin composition was cooled to a temperature suitable for expansion, extruded through a die, and thereby yielded a foam.

(Evaluations)

The foams according to the examples and comparative examples were subjected to measurements or evaluations of expansional viscosity, expansion ratio, compression load at 50% compression (50% compression load), and flame retardancy. The results are shown in Table 1.

(Measurement of Expansional Viscosity)

The expansional viscosity was measured according to the following method.

Measuring instrument: twin-capillary rheometer “Model RH7-2” supplied by Rosand Precision Ltd.

Long die: die with a diameter of 1 mm, a length of 16 mm, and an incident angle of 180° (L/D=16)

Short die: die with a diameter of 1 mm, a length of 0.25 mm, and an incident angle of 180° (L/D=0.25)

A sample resin in the form of pellets was charged into a capillary of the capillary rheometer, heated at 180° C. for about 10 minutes, and thereby melted. As a piston was pushed down at a certain speed, the molten resin was extruded via a lower capillary. The pressure of the resin at this time was measured with a pressure sensor provided in the vicinity of the inlet of the capillary. The thus-measured pressure was converted into a viscosity according to the following expression:

P₀=(P_{S}·L_{L}−P_{L}·L_{L})/(L_{L}−L_{S})

wherein P₀: Pressure loss [MPa]

P_{L}: Pressure loss [MPa] measured in the long die

P_{S}: Pressure loss [MPa] measured in the short die

L_{L}: Length [mm] of the long die

L_{S}: Length [mm] of the short die

Based on this, an expansional viscosity λ [kPa·s] was calculated according to the following expression:

λ=9(n+1)2P₀/(32ηγ)

wherein η: Shear rate [1/s]=(100 [1/s])

γ: Shear viscosity [kpa·s] calculated according to τ=k·γn in which τ represents a shear stress [kpa].

n: Power law index

k: Constant

### (Density)

A sample foam was punched with a punch die 40 mm long and 40 mm wide to give a punched specimen, and the size of the punched specimen was measured. Independently, the thickness of the specimen was measured with a 1/100 scaled dial gauge having a measuring terminal 20 mm in diameter (φ). The volume of the foam was calculated from these data. Next, the weight of the foam was measured with an even balance having a minimum scale of 0.01 g or more. The density (g/cm³) of the foam was calculated from these data. As used herein the “density of the foam” refers to a density after expansion.

### (Expansion Ratio)

The density of a sample before expansion was measured by the procedure as in the item (Density), and the expansion ratio was determined according to the following expression:

Expansion ratio (time)=(Density before expansion)/(Density after expansion)

In the expression, the density before expansion refers to the density of each pellet obtained in the examples and comparative examples; and the density after expansion refers to the apparent density of each foam obtained in the examples and comparative examples.

### (Compression Load at 50% Compression)

The compression load at 50% compression was measured in accordance with the method of measuring a compression hardness prescribed in JIS K 6767. Specifically, a sample foam was cut into a circular specimen 20 mm in diameter, the specimen was compressed to 50% of the initial thickness at a rate of 10 mm/min, a load (N) was measured 20 seconds into the compression, and the measured load was converted into a value per unit area (1 cm²) as the compression load at 50% compression (N/cm²).

### (Evaluation of Flame Retardancy)

The flame retardancy was evaluated by conducting a horizontal burning test as prescribed in UL94 Flame Ratings (the procedure and conditions of the test herein were in accordance with JIS K 6400-6). Specifically, specimens (length: 150±1 mm, width: 50±1 mm, thickness: 0.3 mm and 1.2 mm) were held horizontally, brought into contact with 38 mm flame for 60 seconds, and the flame retardancy was evaluated based on the burning rate between bench marks of a 100 mm span and the burning behavior.

TABLE 1

| | | Example | Example | Example | Example | Example | Example | Com. | Com. | Com. | Com. |
|---|---|---|---|---|---|---|---|---|---|---|---|
| | | 1 | 2 | 3 | 4 | 5 | 6 | Ex. 1 | Ex. 2 | Ex. 3 | Ex. 4 |
| Composition | Polyolefinic | 55 | 55 | 55 | 50 | 50 | 35 | 55 | 55 | 55 | 55 |
| [part by | elastomer | | | | | | | | | | |
| weight] | Polypropylene | 45 | 45 | 45 | 50 | 50 | 65 | 45 | 45 | 45 | 45 |
| | Stearic acid | 1 | 1 | 1 | 1 | 1 | 1 | 1 | 1 | 1 | 1 |
| | monoglyceride | | | | | | | | | | |
| | Lauric bisamide | 1 | 1 | 1 | 1 | 1 | 1 | 1 | 1 | 1 | 1 |
| | Carbon (carbon | 10 | 10 | 10 | 10 | 10 | 10 | 10 | 10 | 10 | 10 |
| | black CB) | | | | | | | | | | |
| | Polysiloxane- | 60 | 90 | 120 | 120 | 75 | 75 | — | — | — | — |
| | coated | | | | | | | | | | |
| | magnesium | | | | | | | | | | |
| | hydroxide | | | | | | | | | | |
| | Silane- | — | — | — | — | — | — | 10 | 60 | 90 | 120 |
| | coupling- | | | | | | | | | | |
| | agent-treated | | | | | | | | | | |
| | magnesium | | | | | | | | | | |
| | hydroxide | | | | | | | | | | |

| | | | | | | | | | | |
|---|---|---|---|---|---|---|---|---|---|---|
| Content of flame retarder | 34.9 | 44.6 | 51.7 | 51.7 | 40.1 | 40.1 | 8.2 | 34.9 | 44.6 | 51.7 |
| [% by weight] | | | | | | | | | | |
| Expansional viscosity [kPa · s] | 58.3 | 61.6 | 66.2 | 68.9 | 60.3 | 69.8 | 43.6 | 62.9 | 65.1 | 77.9 |
| (temperature: 180° C., | | | | | | | | | | |
| shear rate: 100 [1/s]) | | | | | | | | | | |
| Density of resin pellet | 1.15 | 1.25 | 1.31 | 1.30 | 1.19 | 1.17 | 0.96 | 1.14 | 1.24 | 1.33 |
| (density before expansion) | | | | | | | | | | |
| [g/cm³] | | | | | | | | | | |
| Density of foam (density | 0.060 | 0.063 | 0.074 | 0.082 | 0.061 | 0.054 | 0.040 | 0.087 | 0.119 | 0.144 |
| after expansion) [g/cm³] | | | | | | | | | | |
| Expansion ratio [time] | 19.2 | 19.8 | 17.7 | 15.9 | 19.5 | 21.7 | 24.0 | 13.1 | 10.4 | 9.2 |
| Compression load at | 1.68 | 1.75 | 1.86 | 1.82 | 1.95 | 2.47 | 1.50 | 2.46 | 3.10 | 3.60 |
| 50% compression [N/cm²] | | | | | | | | | | |
| Flame retardancy | HBF | HF-1 | HF-1 | HF-1 | HBF | HBF | failed | failed | HBF | HF-1 |
| (UL94 Flame Ratings, | | | | | | | | | | |
| horizontal burning test) | | | | | | | | | | |

The data of the working examples demonstrate that resin foams show high flame retardancy when each containing a flame-retardant component in a content of 30 percent by weight or more. The comparison between Example 1 and Comparative Example 2 indicates that these samples significantly differ from each other in flame retardancy even at an identical content of the flame retardant component, demonstrating that the polysiloxane-coated flame retarder helps the resin foam to have higher flame retardancy. The comparison between Examples 1 to 3 and Comparative Examples 2 to 4 indicates that the resin foams according to Examples 1 to 3 each have a higher expansion ratio than that of a corresponding comparative example even at an identical content of the flame-retardant component, demonstrating that the use of the polysiloxane-coated flame retarder gives highly expanded resin foams. In addition, the data regarding Comparative Example 1 and Comparative Example 2 demonstrate that foams, if containing the silane-coupling-agent-treated flame retarder in a small amount, do not exhibit flame retardancy although being flexible. Thus, the foams according to the examples, as employing the polysiloxane-coated flame retarder, are highly expanded, have satisfactory flame retardancy, and are highly flexible.

### INDUSTRIAL APPLICABILITY

The resin foams and frame-retardant foam materials according to the present invention have both flexibility and flame retardancy, are highly expanded, are lightweight, and are capable of conforming to a minute clearance. They are advantageously usable typically as sealants, cushioning sealants, shock absorbers, dustproof materials, soundproof materials, and waterproof materials.

1. A resin foam comprising a resin and a flame-retardant component, wherein the flame-retardant component is a polysiloxane-coated flame retarder.

2. The resin foam according to claim 1, wherein the polysiloxane-coated flame retarder is a polysiloxane-coated metal hydroxide, and wherein the polysiloxane-coated metal hydroxide is contained in a content of from 30 to 60 percent by weight based on the total weight of the resin foam.

3. The resin foam according to claim 1, wherein the resin foam has a compression load at 50% compression of 3.0 N/cm² or less and has a flame retardancy of HBF rating or higher as determined in a frame-retardant test according to UL94 Flame Ratings.

4. The resin foam according to claim 1, wherein the resin foam has an expansion ratio of 9 times or more.

5. The resin foam according to claim 1, wherein the resin foam has a density of from 0.030 to 0.120 g/cm³.

6. The resin foam according to claim 1, wherein the resin is a thermoplastic resin.

7. The resin foam according to claim 1, wherein the resin foam has a closed cell structure or semiopen/semiclosed cell structure.

8. The resin foam according to claim 1, wherein the resin foam has been formed through the steps of impregnating the resin with an inert gas under high pressure; and decompressing the impregnated resin.

9. The resin foam according to claim 8, wherein the inert gas at the impregnation is carbon dioxide.

10. The resin foam according to claim 8, wherein the inert gas is in a supercritical state at the impregnation.

11. A foam material comprising the resin foam according to claim 1.

12. The foam material according to claim 11, further comprising a pressure-sensitive adhesive layer present on or above one or both sides of the resin foam.

13. The foam material according to claim 12, further comprising a film layer present between the resin foam and the pressure-sensitive adhesive layer.

14. The foam material according to claim 12, wherein the pressure-sensitive adhesive layer is an acrylic pressure-sensitive adhesive layer.
